(19) United States
(12) Patent Application Publication
(10) Pub. No.: US 2017/0164194 A1
(43) Pub. Date: Jun. 8, 2017

(54) OFFLOADING OF A WIRELESS NODE AUTHENTICATION WITH CORE NETWORK

(71) Applicant: Nokia Solutions and Networks Oy, Espoo (FI)

(72) Inventors: Frank Frederiksen, Klarup (DK); Mads Lauridsen, Aalborg Ost (DK)

(21) Appl. No.: 15/316,702

(22) PCT Filed: Jun. 26, 2014
(86) PCT No.: PCT/EP2014/063527

§ 371 Date: Dec. 6, 2016

(51) Int. Cl. H04W 12/06; H04W 76/06; H04W 36/00; H04L 29/06

(52) U.S. Cl. CPC H04W 12/06; H04L 63/083; H04L 63/0428; H04W 76/064; H04W 36/0011

(57) ABSTRACT

An example technique may include controlling receiving, by a second node from a first node in a wireless network, a request to offload authentication of the first node with the core network to the second node, controlling receiving, by the second node from the first node, data to be forwarded to the core network, performing, by the second node based on the request, an authentication with the core network on behalf of the first node while the first node is not connected with the second node, and controlling forwarding the received data from the second node to the core network while the first node is not connected with the second node.

### TECHNICAL FIELD

This description relates to communications.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3^{rd} Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP's Long Term Evolution (LTE) upgrade path for mobile networks. In LTE, base stations, which are referred to as enhanced Node Bs (eNBs), provide wireless access within a coverage area or cell. In LTE, mobile devices, or mobile stations are referred to as user equipments (UE). LTE has included a number of improvements or developments.

### SUMMARY

According to an example implementation, a method may include controlling sending, by a first node in a wireless network without the first node being authenticated to a core network, a message to a second node, the message including data to be forwarded to the core network, offloading authentication of the first node with the core network from the first node to the second node, and terminating controlling the sending the message by the first node without the first node performing authentication with the core network.

According to another example implementation, an apparatus includes at least one processor and at least one memory including computer instructions, when executed by the at least one processor, cause the apparatus to: control sending, by a first node in a wireless network without the first node being authenticated to a core network, a message to a second node, the message including data to be forwarded to the core network, offload authentication of the first node with the core network from the first node to the second node, and terminate controlling the sending the message by the first node without the first node performing authentication with the core network.

According to another example implementation, a computer program product includes a computer-readable storage medium and storing executable code that, when executed by at least one data processing apparatus, is configured to cause the at least one data processing apparatus to perform a method including: controlling sending, by a first node in a wireless network without the first node being authenticated to a core network, a message to a second node, the message including data to be forwarded to the core network, offloading authentication of the first node with the core network from the first node to the second node, and terminating controlling the sending the message by the first node without the first node performing authentication with the core network.

According to an example implementation, a method may include controlling receiving, by a second node from a first node in a wireless network, a request to offload authentication of the first node with the core network to the second node, controlling receiving, by the second node from the first node, data to be forwarded to the core network, performing, by the second node based on the request, an authentication with the core network on behalf of the first node, controlling forwarding the received data from the second node to the core network while the first node is not connected with the second node.

According to another example implementation, an apparatus includes at least one processor and at least one memory including computer instructions, when executed by the at least one processor, cause the apparatus to: control receiving, by a second node from a first node in a wireless network, a request to offload authentication of the first node with the core network to the second node, control receiving, by the second node from the first node, data to be forwarded to the core network, perform, by the second node based on the request, an authentication with the core network on behalf of the first node, and control forwarding the received data from the second node to the core network while the first node is not connected with the second node.

According to another example implementation, a computer program product includes a computer-readable storage medium and storing executable code that, when executed by at least one data processing apparatus, is configured to cause the at least one data processing apparatus to perform a method comprising: controlling receiving, by a second node from a first node in a wireless network, a request to offload authentication of the first node with the core network to the second node, controlling receiving, by the second node from the first node, data to be forwarded to the core network, performing, by the second node based on the request, an authentication with the core network on behalf of the first node, and controlling forwarding the received data from the second node to the core network while the first node is not connected with the second node.

According to another example implementation, a method may include controlling receiving, by a second node from each of a plurality of first nodes in a wireless network, data to be forwarded to a core network, the plurality of first nodes associated with a user or a system, aggregating the data received from each of the plurality of first nodes into a set of data, authenticating the user or the system to the core network, and controlling forwarding the aggregated set of data from the second node to the core network.

According to another example implementation, an apparatus includes at least one processor and at least one memory including computer instructions, when executed by the at least one processor, cause the apparatus to: control receiving, by a second node from each of a plurality of first nodes in a wireless network, data to be forwarded to a core network, the plurality of first nodes associated with a user or a system, aggregate the data received from each of the plurality of first nodes into a set of data, authenticate the user or the system to the core network, and control forwarding the aggregated set of data from the second node to the core network.

A computer program product includes a computer-readable storage medium and storing executable code that, when executed by at least one data processing apparatus, is configured to cause the at least one data processing apparatus to perform a method including: controlling receiving, by a second node from each of a plurality of first nodes in a wireless network, data to be forwarded to a core network, the plurality of first nodes associated with a user or a system, aggregating the data received from each of the plurality of first nodes into a set of data, authenticating the user or the system to the core network, and controlling forwarding the aggregated set of data from the second node to the core network.

The details of one or more examples of implementations are set forth in the accompanying drawings and the description below. Other features will be apparent from the description and drawings, and from the claims.

### BRIEF DESCRIPTION OF THE DRAWINGS

FIG. 1 is a block diagram of a wireless network 130 according to an example implementation.

FIG. 2 is a timing diagram illustrating operation of a user device in the full functionality mode according to an example implementation.

FIG. 3 is a timing diagram illustrating operation of a user device in limited functionality mode according to an example implementation.

FIG. 4 is a timing diagram illustrating operation of a base station while the user device is operating in the limited functionality mode according to an example implementation.

FIG. 5 is a timing diagram illustrating operation of a user device that transitions between operating modes multiple times according to another example implementation.

FIG. 6 is a diagram illustrating a flow when using either limited functionality mode or full functionality mode according to an example implementation.

FIG. 7 is a diagram illustrating operation of a wireless system when a user device operates in a limited functionality mode according to an example implementation.

FIG. 8 is a diagram illustrating a use of an authentication agent to generate an authentication response as part of the authentication procedure illustrated in FIG. 7 according to an example implementation.

FIG. 9 is a diagram illustrating an example of a wireless node 916 that performs data aggregation and authentication for a plurality of nodes according to an example implementation.

FIG. 10 is a flow chart illustrating operation of a user device according to an example implementation.

FIG. 11 is a flow chart illustrating operation of a base station according to an example implementation.

FIG. 12 is a flow chart illustrating operation of a wireless node according to an example implementation.

FIG. 13 is a block diagram of a wireless station (e.g., BS or user device or other wireless node) 1300 according to an example implementation.

### DETAILED DESCRIPTION

Various example implementations are provided relating to an offloading of wireless node authentication. According to an example implementation, a user device (or other node) may operate in a limited functionality mode of operation in which the user device is connected with a base station (BS) to transmit data to the BS. According to an example implementation, rather than the user device performing authentication with a core network, authentication of the user device to the core network may be offloaded to the BS or other node to allow the user device to more quickly return to a low power or sleep mode.

An example implementation may include controlling sending, by a first node in a wireless network without the first node being authenticated to a core network, a message to a second node, the message including data to be forwarded to the core network, offloading authentication of the first node with the core network from the first node to the second node, and terminating controlling the sending the message by the first node without the first node performing authentication with the core network.

Another example implementation may include controlling receiving, by a second node from a first node in a wireless network, a request to offload authentication of the first node with the core network to the second node, controlling receiving, by the second node from the first node, data to be forwarded to the core network, performing, by the second node based on the request, an authentication with the core network on behalf of the first node while the first node is not connected with the second node, and controlling forwarding the received data from the second node to the core network while the first node is not connected with the second node.

Another example implementation may include controlling receiving, by a first node from each of a plurality of second nodes in a wireless network, data to be forwarded to a core network, the plurality of second nodes associated with a user or a system, aggregating the data received from each of the plurality of second nodes into a set of data, authenticating the user or the system to the core network, and controlling forwarding the aggregated set of data from the first node to the core network.

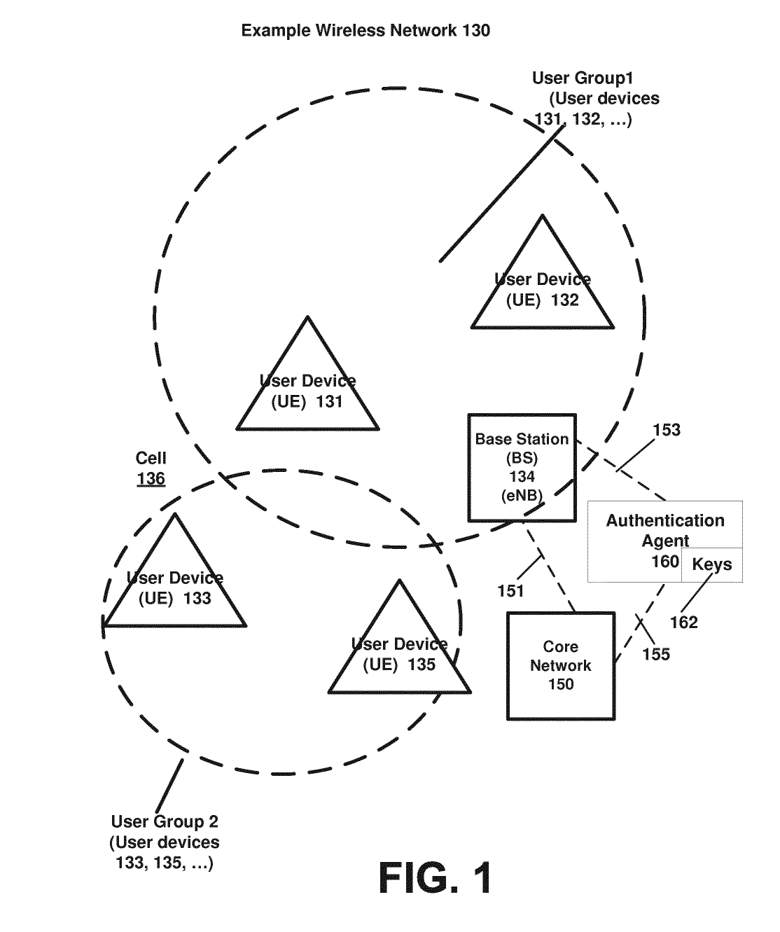

FIG. 1 is a block diagram of a wireless network 130 according to an example implementation. In the wireless network 130 of FIG. 1, user devices 131, 132, 133 and 135, which may also be referred to as user equipments (UEs), may be connected (and in communication) with a base station (BS) 134, which may also be referred to as an enhanced Node B (eNB). At least part of the functionalities of a base station or (e)Node B may be also be carried out by any node, server or host which may be operably coupled to a transceiver, such as a remote radio head. BS 134 provides wireless coverage within a cell 136, including to user devices 131, 132, 133 and 135. Although only four user devices are shown as being connected or attached to BS 134, any number of user devices may be provided. BS 134 is also connected to a core network 150 via a S1 interface 151. This is merely one simple example of a wireless network, and others may be used.

A user device (user terminal, user equipment (UE)) may refer to a portable computing device that includes wireless mobile communication devices operating with or without a subscriber identification module (SIM), including, but not limited to, the following types of devices: a mobile station, a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, and a multimedia device, as examples. It should be appreciated that a user device may also be a nearly exclusive uplink only device, of which an example is a camera or video camera loading images or video clips to a network.

In LTE (as an example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks.

According to an example implementation, user devices 131, 132, 133 and 135 may be in proximity to each other. User device 131 and 132 may be part of user group 1 (e.g., D2D user group 1), while user devices 133 and 135 may be part of user group 2 (e.g., D2D user group 2), for example. Alternatively, user devices 131, 132, 133 and 135 may be part of the same user group. One of the user devices, such as user device 131 may also operate as a multi-user group cluster head. A cluster head may transmit synchronization signals, and may also transmit a channel occupation (or channel occupancy) information for one or more channels including, for each channel, identifying whether the channel is free or occupied, and identify the user group that is occupying the channel and/or the user device ID of the user device that is occupying the channel if the channel is occupied, for example, or provide/transmit other control information to other user devices.

According to an example implementation, the user devices 131, 132, 133 and/or 135 may operate in a proximity-based services mode, such as a device-to-device (D2D) mode of operation in which user devices may directly communicate with each other. Thus, for a proximity-based services (Pro-Se) wireless network, such as a user device operating in a D2D mode, communications may occur directly between user devices, rather than passing through BS 134, for example. D2D communications may be performed, for example, in the event of a breakage of S1 interface 151 or other network failure. Alternatively, user devices may perform D2D communications even when no such network failure has occurred, such as, for example, to offload traffic from the network (BS 134 and/or core network 150) and/or to allow user devices to communicate directly in a D2D mode, even in absence of network coverage.

Therefore, the various techniques and example implementations described herein may be applicable to a user device that communicates via a BS (such as BS 134), which may also be referred to as infrastructure mode, and/or for user devices that communicate directly with one or more other user devices, such as for a proximity-based services (Pro-Se) wireless network or a D2D mode of operation for the user device. In addition, the various techniques and example implementations described herein may be applied, for example, to devices that may implement at least a portion of the LTE standard (and improvements to LTE, such as LTE-Advanced, etc.), and also to non-LTE devices, e.g., which may implement other standards or protocols in some cases.

According to an example implementation, a user device (or other node) may operate in a limited functionality mode of operation in which the user device is connected with a base station (BS) to transmit data to the BS, but the user device does not perform authentication with the core network. Rather, according to an example implementation, for limited functionality mode, authentication of the user device with the core network is offloaded to the BS or other node to allow the user device to more quickly return to a low power or sleep mode.

For example, a user device may exit a sleep mode or low power mode (e.g., RRC_Idle mode), may establish a connection with a BS by performing a random access procedure (or other connection establishment procedure) with the BS. Once the user device is connected to the BS, the user device may transmit data to the BS along with a request to offload authentication of the user device, and then the user device may immediately return to a low power or sleep mode (e.g., RRC_Idle), without the user device performing authentication with the core network. Rather, the authentication procedure (e.g., mutual authentication) between the user device and the core network may be offloaded from the user device to the BS, e.g., to allow the user device to immediately return to low power or sleep mode (e.g., RRC_Idle) after the user device completes transmission of the data to the BS, e.g., before the user device has been authenticated to the core network by the BS. Thus, by offloading authentication of the user device with the core network to the BS, the user device may save power by more quickly returning to a low power or sleep mode. Once the BS has authenticated the user device to the core network, the BS may then forward any data that was received from the user device to the core network and/or receive any data from the core network for the user device (where such data received from the core network may be stored at the BS and later forwarded to the user device when the user device is active again).

Table 1 below summarizes three example modes of operation for a user device according to an example implementation.

TABLE 1
Example Modes of Operation

| Mode | Connection | Functionality | Latency |
|---|---|---|---|
| A. Full function- | User device is | For example, data | Long latency in |
| ality (e.g., | connected to | transfer and | setting up the |
| RRC_Connected) | the core net- | exchange of | authentication/ |
| | work via the | network/user de- | connection with |
| | base station | vice settings/ | the core network |
| | | parameters be- | before sending |
| | | tween user de- | data |
| | | vice and core | |
| | | network | |
| B. Limited | User device is | For example, | Much shorter |
| functionality | connected to | exchange of data, | latency than |
| (e.g., | the base sta- | network/user de- | mode A, e.g., |
| RRC_Limited) | tion; user de- | vice settings/ | based on |
| | vice authen- | parameters be- | offloading of |
| | tication may | tween BS and | user device |
| | be offloaded | core network | authentication to |
| | to BS to allow | (e.g., forward | core network |
| | user device to | data from BS to | |
| | more quickly | core network) | |
| | return to low | | |
| | power/sleep | | |
| | mode (or min. | | |
| | functionality) | | |
| C. Minimum | User device | User device can | Long latency for |
| functionality | periodically | receive paging | paging |
| (e.g., | wakes up and | messages and | messages; user |
| RRC_Idle) | scans the | may measure | device |
| | network | received signals | conserves |
| | | in the network | greatest battery |
| | | | power in this |
| | | | mode as |
| | | | compared to |
| | | | other modes |

As shown in Table 1, according to an example implementation, in minimum functionality mode (mode C in Table 1), the user device may periodically wake up to receive paging messages and/or may measure signals from one or more base stations. The user device may conserve significant battery power while in this minimum functionality mode.

As shown in Table 1, according to an example implementation, in full functionality mode (mode A in Table 1), the user device is connected to the core network via the BS. For example, the user device may perform authentication with the core network and then send/receive data, parameters, etc. with the core network via the BS. However, a significant latency may occur for the user device in the full functionality mode because of the user device waiting for an authentication request/challenge, generating and sending an authentication response to the core network, and awaiting for an acknowledgement before sending data to the core network via the BS, for example.

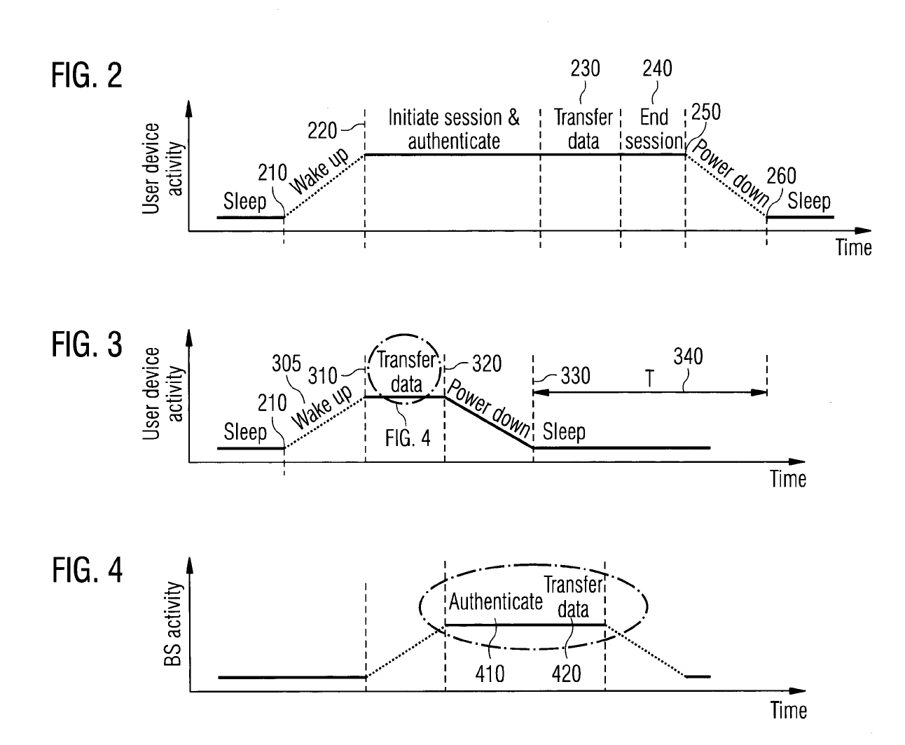

FIG. 2 is a timing diagram illustrating operation of a user device in the full functionality mode according to an example implementation. At 210, the user device wakes from a sleep or low power mode (e.g., RRC_Idle) and wakes up, or applies power to one or more electronic components, and may establish a connection to the BS by performing a random access procedure with the BS, for example. Thus, the user device may transition from a low power or sleep mode (e.g., RRC_Idle) to a connected mode (e.g., RRC_Connected) by establishing a wireless connection with the BS, e.g., via a random access procedure or other connection establishment procedure, for example.

At 220, the user device may perform authentication (e.g., mutual authentication) with the core network, in order to authenticate the user device to the core network. This may be accomplished, for example, by the user device receiving an authentication request or challenge from the core network, generating an authentication response based on a key associated with the user device, and sending the authentication response to the core network via the BS.

Once the user device is authenticated with the core network at 220, the user device may send or transfer data to the core network via the BS at 230. The user device may end the session with the core network and transition to low power or sleep (e.g., RRC_Idle) mode at 240, power down one or more components at 250 into sleep mode at 260, for example. However, the user device performing authentication may create a significant latency or delay for the user device before the user device may transmit or send data.

As shown in Table 1, according to an example implementation, in limited functionality mode (mode B in Table 1), the user device is connected to the BS, and user device authentication with the core network may be offloaded to the BS. Offloading user device authentication may allow the user device to more quickly return to a low power or sleep mode (or RRC_Idle or minimum functionality mode) to save additional battery power or extend battery life, as compared to full functionality mode.

FIG. 3 is a timing diagram illustrating operation of a user device operating in limited functionality mode according to an example implementation. FIG. 4 is a timing diagram illustrating operation of a base station while the user device is operating in the limited functionality mode according to an example implementation. Referring to FIGS. 3 and 4, at 305, a user device may exit low power or sleep mode (e.g., RRC_Idle) by waking up or applying power to one or more components, and then establishing a connection with the BS, e.g., by performing a random access procedure with the BS, e.g., to transition to limited functionality mode or RRC_Limited, as an example. At 310, the user device may send or transfer data to the BS, e.g., along with a user device ID (e.g., MAC address of user device, C-RNTI (Cell Radio Network Temporary Identifier), IMSI (International Mobile Subscriber Identifier), or other identifier of user device), and a request to offload user device authentication, for example.

Referring to FIGS. 3 and 4 with respect to the limited functionality mode of the user device, after the user device transfers data to the BS at 310, the user device may transition to sleep mode or low power mode (e.g., RRC_Idle) and power down one or more components at 320, and sleep at 330 for at least a period T during 340, for example. The BS may receive the data (e.g., and possibly a request to offload user device authentication to the BS) from the user device, and then may authenticate the user device to the core network at 410, and then transfer the data (received from the user device) to the core network at 420.

Note that the user device in limited functionality mode (FIG. 3) may return to low power or sleep mode (e.g., RRC_Idle or minimum functionality mode) more quickly than in full functionality mode (FIG. 4). For example, user device may transfer data at 310 before authentication, and then immediately power down or transition to a low power or sleep mode at 320 and 330. Whereas, as shown in FIG. 2, in full functionality mode, the user device does not (in this illustrative example) transition to a low power or sleep mode until the user device has performed authentication with core network and transferred data to the core network via the BS. Thus, for example, as shown in FIGS. 3-4, user device in limited functionality mode (FIG. 3) may enter sleep or low power mode T seconds (340) before a user device would enter low power or sleep mode in full functionality mode (FIG. 2).

In one example implementation, the user device may request (either in advance as part of capabilities exchange or other message, or as part of a data transfer) an offloading of user device authentication with core network from user device to BS in limited functionality mode (e.g., RRC_Limited), whereas no such offloading request is typically provided by the user device while in full functionality mode (e.g., RRC_Connected), although the user device is considered connected to BS in both full functionality mode (e.g., RRC_Connected) and limited functionality mode (e.g., RRC_Limited). However, the order of data transfer and user device authentication, as well as which node (user device or BS) performs user device authentication may be different in limited functionality mode vs. full functionality mode, according to an example implementation. For example, in full functionality mode, the user device, after establishing a connection with the BS, performs authentication with the core network and then sends data to the core network via the BS. Whereas, in limited functionality mode, the user device, after establishing a connection to the BS, transfers data to the BS (e.g., with request to offload user device authentication), and then returns to low power or sleep mode (or minimum functionality) without performing authentication with the core network. In limited functionality mode, the user device relies upon the BS to perform user device authentication to the core network on behalf of the user device, and then the BS forwards the data received from the user device.

According to an example implementation, the limited functionality mode (e.g., example shown in FIG. 3) provides an advantage (as compared to full functionality mode) in terms of lower latency and reduced energy consumption, because the user device in limited functionality mode may connect and disconnect to the BS faster without performing the complex network authentication, which is offloaded to the BS. According to an example implementation, the energy savings for limited functionality may be achieved due to shorter on/active time for the user device and/or because the processing of the transferred data may be less complex.

According to an example implementation, the use of limited functionality mode (e.g., which may include offloading of user device authentication with core network to the BS) may be used to allow the user device to exchange data and/or network/user device settings or parameters. In another example implementation, the use of the limited functionality mode may also be applicable when data, which is not (or may not be) relevant to the core network is to be transferred to the BS. For example, such data may (by way of example) be related to an updated setting/parameter, which affects the connection between the user device and the BS.

The following is an example (non-exhaustive) list of possible data transfers, which may be performed when the user device is in the limited functionality mode:

1) User device sends Tracking Area Update. For example, sending a tracking area update may be necessary when the user device has moved into a new coverage area (e.g., in an example of such case, the user device may just send information identifying the BS that the user device was previously connected to, and leave it to the current BS to fetch the needed information from the previous serving BS).

2) Base station sends a network reconfiguration update to the user device or core network.

3) User device sends an update to BS (to also be forwarded to the core network) with its current capabilities. This may occur, e.g., if the battery level of the user device is low or lower than a threshold.

4) User device sends a report to BS with measurement report, e.g., which may include measurements of reference signals from other cells or nodes (e.g., measured signals from other BSs or other user devices). This information may be forwarded to the core network, e.g., to be used for handover decisions made by the core network.

5) User device sends an update to BS with change request for sleep/paging schedule or patterns, which may be forwarded to the core network.

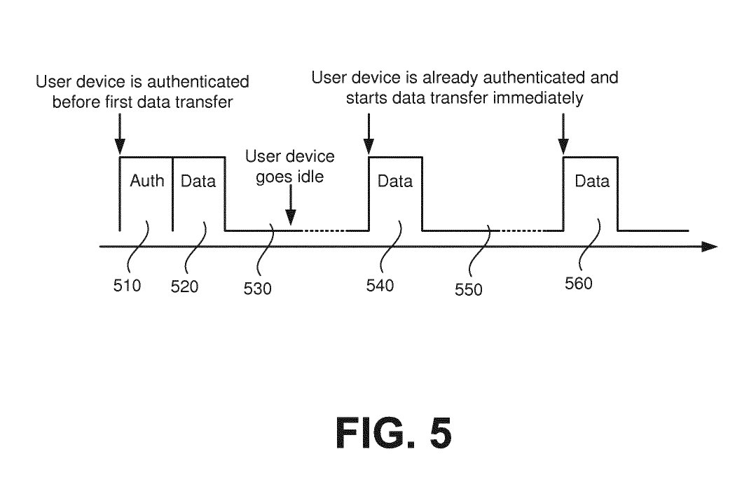

FIG. 5 is a timing diagram illustrating operation of a user device that transitions between operating modes multiple times according to another example implementation. As shown in FIG. 5, a user device may be authenticated to the core network at 510. User device authentication may be performed at 510 by the user device in full functionality mode, or by the base station when the user device is in limited functionality mode (e.g., the user device authentication has been offloaded to the BS). Subsequently, at 520, the user device sends or transfers data to the BS, and then at 530, goes to a low power or sleep mode, e.g., RRC_Idle. In this illustrative example, the user device has already been authenticated to the core network at 510, and there is no need to repeat such user device authentication with core network, e.g., for at least a period of time (such as for 30 minutes as an example). Therefore, for one or more active periods 540 and 560, e.g., where the user device awakes from low power or sleep mode to limited functionality mode or full functionality mode, the user device may simply send the data to the BS, and then return to sleep or low power mode at 550. The BS may simply forward the received data to the core network without additional user device authentication, since the user device was recently authenticated to the core network. However, the core network may require periodic authentication, or that a user device authentication will be valid only for a period of time. Once the period of time has expired since the user device was last authenticated to the core network, the user device may need to be re-authenticated to the core network, for example.

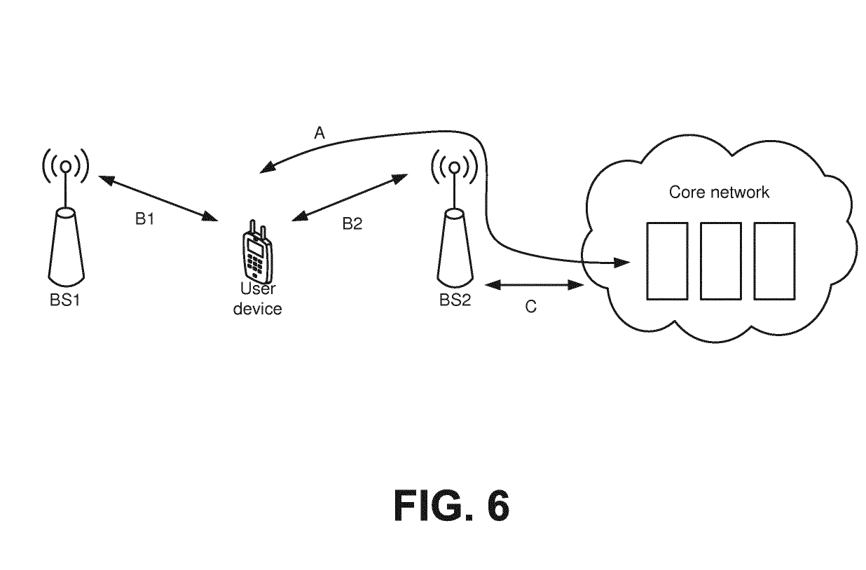

FIG. 6 is a diagram illustrating a flow when using either limited functionality (B1 or B2) or full functionality (A, which include paths or connections B2 combined with C) according to an example implementation. In the full functionality mode, the user device is connected to the core network (e.g., connected to the data service) via connection path A to core network, for example, which may include a connection B2 from the user device to BS2 and a connection C from BS2 to core network. In the limited functionality mode, the user device may include only a connection (and only communicate) with base station BS1 via connection B1, or to BS2 via connection B2, but the user device is not connected to the core network. However, according to an example implementation, the (offloaded) authentication of the user device by the BS to the core network and subsequent forwarding of data from the BS to the core network may be transparent to the core network, e.g., the core network may not receive an indication that the user device authentication and/or data transfer to the core network is performed in a special mode (e.g., limited functionality mode) in which the authentication has been offloaded to the BS. For example, the offloading of user device authentication with the core network may typically be transparent (or unknown) to the core network, for example.

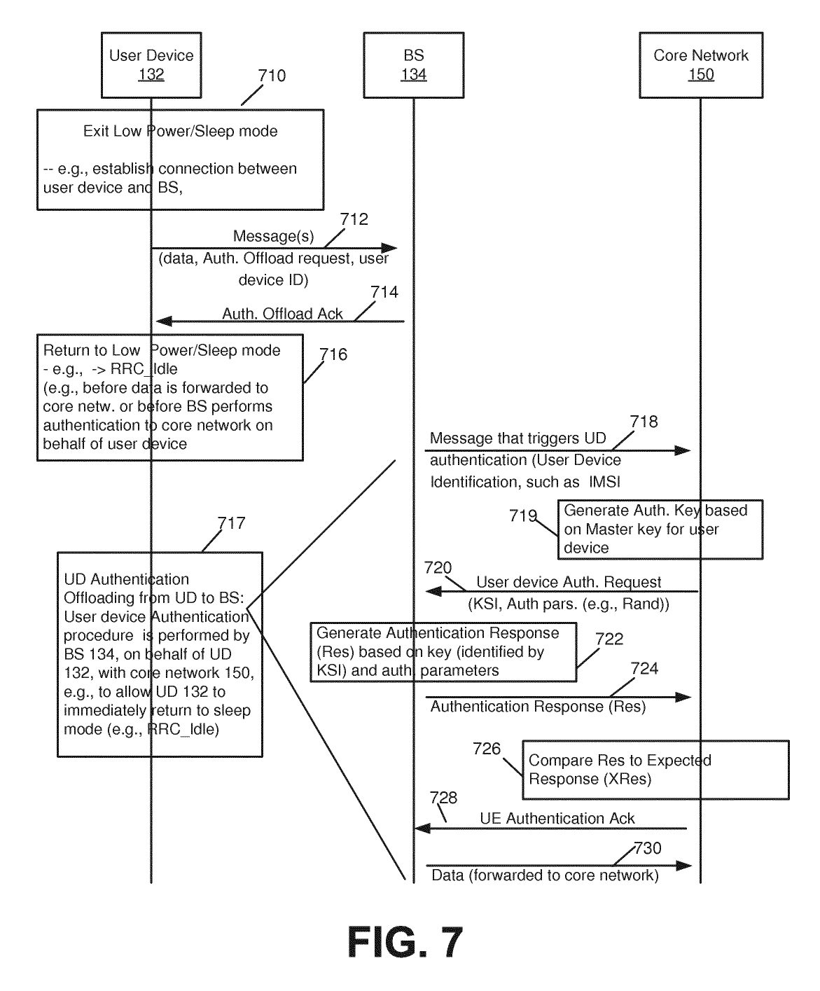

FIG. 7 is a diagram illustrating operation of a wireless system when a user device operates in a limited functionality mode according to an example implementation. A user device 132, a base station (BS) 134 and a core network 150 are shown in FIG. 7. At 710, user device 132 may exit a low power or sleep mode (e.g., exit RRC_Idle), e.g., by performing a random access procedure, or other connection establishment procedure, to establish a connection with BS 134. At 712, user device 132 may send one or more messages to BS 134, which may include, for example, data, an authentication offload request, and a user device ID. The authentication offload request may have been transmitted in advance, or may be sent via separate message to BS 134, for example. At 714, BS 134 receives the data from the user device, and sends an authentication offload acknowledgement, e.g., to acknowledge to user device 132 that BS 134 received the data and will authenticate the user device and forward the data to the core network 150. At 716, user device 132 may then return to the low power or sleep mode (e.g., RRC_Idle or minimum functionality mode) in order to conserve power. For example, user device 132 may return to a low power or sleep mode before BS 134 has authenticated the user device 132 to core network 150 or forwarded the data to core network 150.

At 717, the BS 134 authenticates the user device 132 to the core network 150 (e.g., based on the authentication offload request at 712). For example, at 717, the user device authentication (e.g., mutual authentication) with core network 150 may be performed by the BS 134 on behalf of user device 132. There are a variety of different ways the authentication may be performed, and some example authentication techniques are described by way of example. However, these examples are merely illustrative examples and the various techniques described herein are not limited to such examples.

Referring to FIG. 7, an example implementation of user device authentication 717 is illustrated via operations 718, 719, 720, 722, 724, 726, 728 and 730. At 718, BS 134 may send a message (e.g., which may include the IMSI or other identifier of the user device 132) to core network 150 that triggers a user device authentication procedure. At 719, core network 150 may generate an authentication key based on a master key for the user device 132. At 720, core network may send a user device authentication request, e.g., including a KSI (e.g., key set identifier that identifies the authentication key), and one or more additional authentication parameters such as a random number (RAND). At 722, BS 134 may generate an authentication response (Res) based on the authentication key for the user device and the random number, e.g., by encrypting the random number using the encryption key. Therefore, for BS 134 to generate the authentication response, BS 134 may store, or may have access to, one or more keys (e.g., master key, authentication key, . . . ) associated with the user device 132, according to an example implementation.

At 724, the BS 134 sends the authentication response to the core network. At 726, the core network 150 similarly generate an expected response based on the authentication key for the user device and the random number, and compares the expected response to the authentication response received from the BS 134. If the expected response matches the received authentication response, this indicates that the user device has been authenticated to the core network. At 728, core network 150 sends an authentication acknowledgement to the BS 134 indicating that the user device 132 has been authenticated. The BS 134 forwards the data, which was received by BS 134 from user device 132 at 712, to the core network, and may receive data or signals from the core network 150 to be sent to the user device 132. At 730, BS 134 forwards the data to the core network.

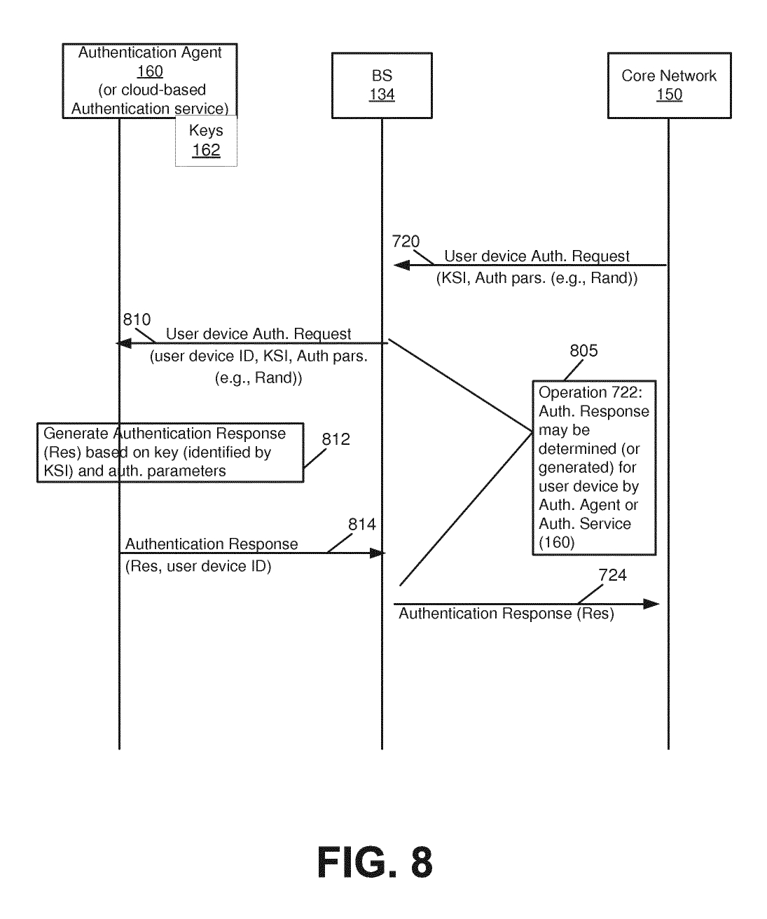

FIG. 8 is a diagram illustrating a use of an authentication agent to generate an authentication response as part of the authentication procedure illustrated in FIG. 7 according to an example implementation. In response to receiving the user device authentication request at 720 from core network 150, the BS 134 may communicate with an authentication agent 160 to obtain an authentication response, via operations 810, 812 and 814. At 810, the BS 134 forwards the user device authentication request to authentication agent 160. At 812, authentication agent 160, which may have stored in key storage 162 or have access to one or more keys (e.g., master key or authentication key) associated with the user device 132, generates an authentication response based on the authentication key (e.g., identified by KSI parameter in the authentication request) for the user device and the random number. At 814, authentication agent 160 sends the authentication response to the BS 134. At 724, BS 134 forwards the authentication response to the core network 150 in order to authenticate the user device to the core network 150.

The implementation shown in FIG. 7 may require the BS 134 to store or have access to one or more keys associated with the user device 132. On the other hand, the implementation shown in FIG. 8, which relies on an authentication agent 160, may not require any keys to be stored at a BS 134, but may allow keys (e.g., stored in secure key storage 162) for multiple user devices to be securely stored by an authentication agent 160 (e.g., which may be a network-based security service, or a cloud-based security service), rather than storing keys on each of a plurality of base stations. Therefore, the implementation shown in FIG. 8 may offer a more secure alternative for the storage of keys associated with one or more user devices. The authentication agent may be provided on a BS, a server, a mobile station, or other device.

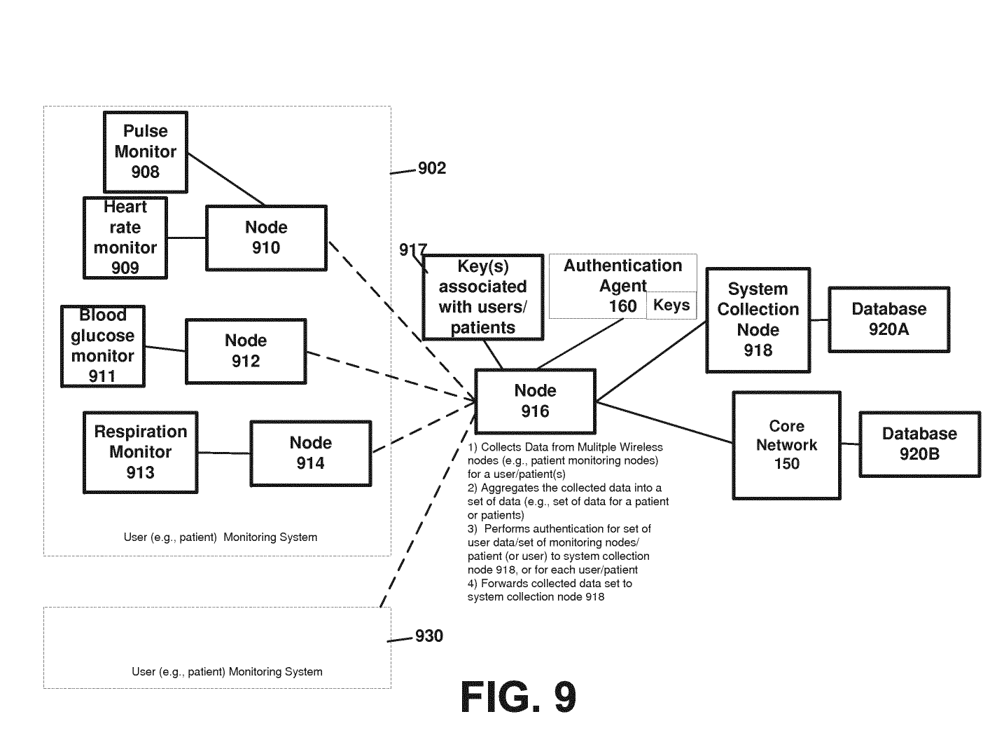

FIG. 9 is a diagram illustrating an example of a wireless node 916 that performs data aggregation and authentication for a plurality of nodes according to an example implementation. A user (e.g., patient) monitoring system 902 may include one or more wireless nodes (e.g., user devices or other nodes), such as node 910 which may receive patient/user health data from a pulse monitor 908 and a heart rate monitor 909, node 912 which may receive user/patient data from a blood glucose monitor 911, and node 914 which may receive user/patient data from a respiration monitor. Similarly, additional user/patient monitoring systems may be provided for one or more additional users/patients, such as user (patient) monitoring system 930, which may similarly include one or more wireless nodes that receive data from one or more monitors/monitoring devices.

Wireless node 916 (which may be a user device, base station, relay station, or other node) may receive or collect data (e.g., health or patient monitoring data) from wireless node(s) of one or more user/patient monitoring systems. Node 916 may aggregate the received data from different nodes for a user/patient into a set of data for a patient (or for a set of patients). According to an example implementation, node 916 may then authenticate the user/patient (e.g., based on a user ID or patient ID) or the user monitoring system 902 (e.g., based on a monitoring system ID), or authenticate a set of data as belonging to or associated with a user ID/patient ID, to either a core network 150 or a system collection node 918. For example, node 916 may authenticate each user/patient or monitoring system to system collection node 918 or to core network 150, e.g., based on a key(s) associated with the user ID/patient ID or a key associated with the monitoring system 902.

Referring to FIG. 9, after authentication has been performed, the set of data for the user/patient received from the one or more nodes of the user/patient monitoring system 902 is then forwarded from the node 916 to either a system collection node 918 (e.g., where such patient data may be stored in database 920A) or to core network 150 where such user/patient data may be forwarded via a network to database 920B, as examples. User patient data, after being stored, may be analyzed by one or more health analysis programs, for example. For example, node 916 may authenticate a user/patient ID or a monitoring system ID or a set of data, based on a key(s) stored at node 916 or accessible to node 916 in the same or similar manner as performed by BS 134 in FIG. 7. Or node 916 may perform authentication by relying on authentication agent 160 to generate an authentication response in a same or similar fashion as described in FIG. 8. This process may be repeated, for example, for each patient, user or for each monitoring system 902, 930, etc.

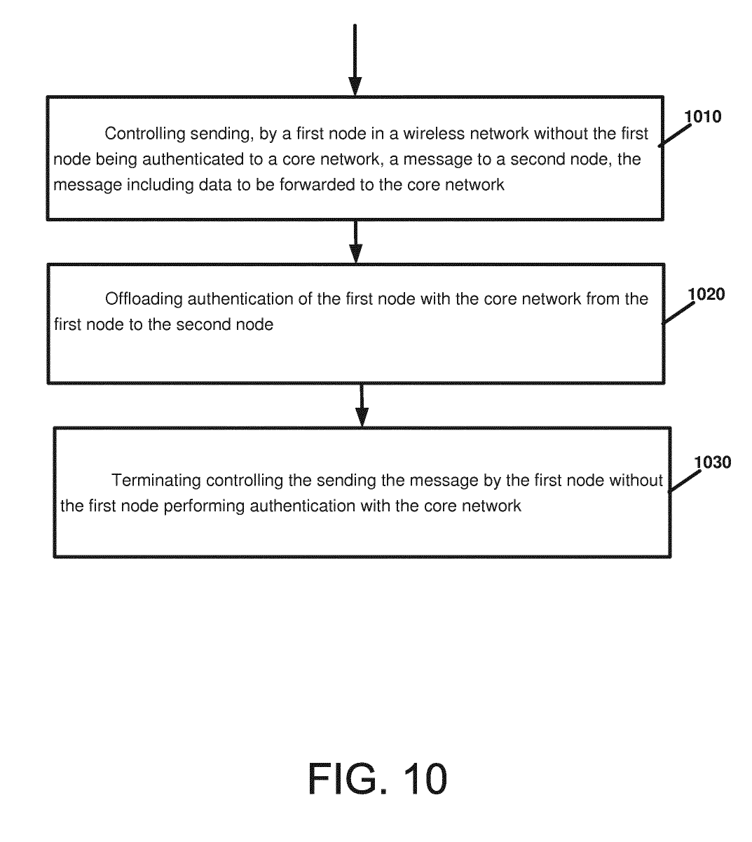

FIG. 10 is a flow chart illustrating operation of a user device according to an example implementation. Operation 1010 includes controlling sending, by a first node in a wireless network without the first node being authenticated to a core network, a message to a second node, the message including data to be forwarded to the core network. Operation 1020 includes offloading authentication of the first node with the core network from the first node to the second node. Operation 1030 includes terminating controlling the sending the message by the first node without the first node performing authentication with the core network.

In an example implementation of the method of FIG. 10, the first node may include a user device, and the second node may include a base station, or, the first node may include a first user device, and the second node may include a second user device.

In an example implementation of the method of FIG. 10, the method may further include connecting, by the first node to the second node, before controlling the sending of the message to the second node, and disconnecting, by the first node from the second node, after terminating controlling the sending the message.

In an example implementation of the method of FIG. 10, the connecting may include transitioning, by the first node, from a RRC_Idle state to a RRC_Connected state based on the first node becoming connected to the second node, before controlling the sending of the message from the first node to the second node, and the disconnecting may include transitioning, by the first node, from the RRC_Connected state back to the RRC_Idle state, after terminating controlling the sending the message.

In an example implementation of the method of FIG. 10, the connecting may include exiting, by the first node, a sleep mode, before controlling the sending of the message from the first node to the second node. And, the disconnecting may include returning, by the first node, to the sleep mode, after terminating controlling the sending the message and before the second node performs authentication with the core network on behalf of the first node.

In an example implementation of the method of FIG. 10, the connecting, by the first node to the second node, may include: applying power to one or more electronic components or portions thereof of the first node, and performing, by the first node, a random access procedure with the second node.

In an example implementation of the method of FIG. 10, message includes the data to be forwarded to the core network, information identifying the first node, and information indicating an offloading of authentication of the first node with the core network from the first node to the second node.

In an example implementation of the method of FIG. 10, the method may further include controlling sending a key from the first node to the second node, the key, or a derivation thereof, to be used by the second node to authenticate the first node to the core network or perform authentication with the core network on behalf of the first node, while the first node is not connected to the second node.

In an example implementation of the method of FIG. 10, the offloading authentication may include authenticating, by the second node, the first node to the core network while the first node is disconnected from the second node, and the method may further include forwarding, by the second node, the data to the core network after the second node has authenticated the first node to the core network and while the first node is disconnected from the second node.

In an example implementation of the method of FIG. 10, the offloading authentication may include performing, by the second node on behalf of the first node, mutual authentication with the core network while the first node is disconnected from the second node.

In an example implementation of the method of FIG. 10, the method may further include authenticating, by the second node via communications with an authentication agent that has access to an encryption key associated with the first node, the first node to the core network while the first node is disconnected from the second node.

According to another example implementation, an apparatus may include means for carrying out any of the method operations described herein.

According to another example implementation, a computer program product is provided for a computer, including software code portions for performing the steps of any of the method operations described herein when the product is run on the computer.

According to an example implementation, an apparatus includes at least one processor and at least one memory including computer instructions, when executed by the at least one processor, cause the apparatus to: control sending, by a first node in a wireless network without the first node being authenticated to a core network, a message to a second node, the message including data to be forwarded to the core network, offload authentication of the first node with the core network from the first node to the second node, and terminate controlling the sending the message by the first node without the first node performing authentication with the core network.

According to an example implementation, a computer program product includes a computer-readable storage medium and storing executable code that, when executed by at least one data processing apparatus, is configured to cause the at least one data processing apparatus to perform a method including: controlling sending, by a first node in a wireless network without the first node being authenticated to a core network, a message to a second node, the message including data to be forwarded to the core network, offloading authentication of the first node with the core network from the first node to the second node, and terminating controlling the sending the message by the first node without the first node performing authentication with the core network.

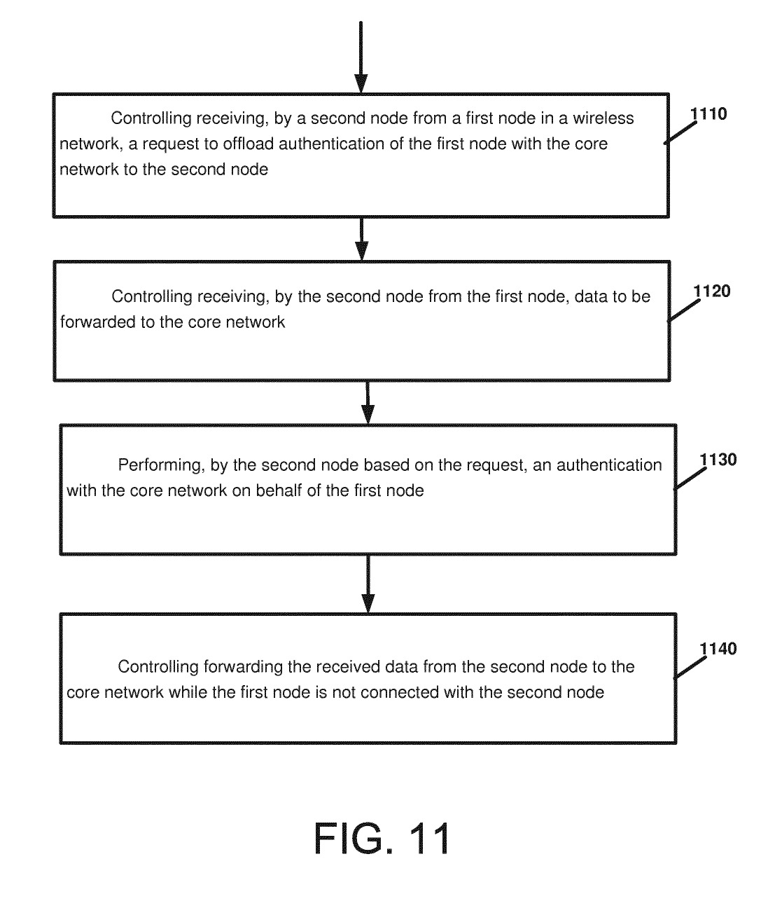

FIG. 11 is a flow chart illustrating operation of a base station according to an example implementation. Operation 1110 includes controlling receiving, by a second node from a first node in a wireless network, a request to offload authentication of the first node with the core network to the second node. Operation 1120 includes controlling receiving, by the second node from the first node, data to be forwarded to the core network. Operation 1130 includes performing, by the second node based on the request, an authentication with the core network on behalf of the first node. And, operation 1140 includes controlling forwarding the received data from the second node to the core network while the first node is not connected with the second node.

In an example implementation of the method of FIG. 11, the first node may include a user device, and the second node may include a base station, or the first node may include a first user device, and the second node may include a second user device.

The method of FIG. 11 may further include controlling sending, by the second node to the first node, a message acknowledging receipt by the second node of the request.

In an example implementation of the method of FIG. 11, the request and the data are received by the second node from the first node via one message.

In an example implementation of the method of FIG. 11, the performing authentication includes authenticating, by the second node, the first node to the core network while the first node is in a sleep mode and is disconnected from the second node.

In an example implementation of the method of FIG. 11, the performing authentication may include: storing, by the second node, a key associated with the first node, and authenticating, by the second node, the first node to the core network using the stored key.

In an example implementation of the method of FIG. 11, the performing authentication may include: controlling receiving, by the second node from the core network, an authentication request for the first node including a random number, generating an authentication response based on the random number and a key associated with the first node, and controlling sending, by the second node to the core network, the authentication response.

In an example implementation of the method of FIG. 11, the performing authentication may include: controlling receiving, by the second node from the core network, an authentication request including a random number, controlling forwarding, by the second node to an authentication agent, the random number and a request for an authentication response based on the random number and a key associated with the first node that is stored by or accessible to the authentication agent, controlling receiving, by the second node from the security agent, an authentication response based on the random number and the key associated with the first node, and controlling sending, by the second node to the core network, the authentication response. In an example implementation of the method of FIG. 11, the security agent is provided by a base station. The method of claim 25 wherein the security agent is provided as a network service or a cloud service.

According to an example implementation, an apparatus includes least one processor and at least one memory including computer instructions, when executed by the at least one processor, cause the apparatus to: control receiving, by a second node from a first node in a wireless network, a request to offload authentication of the first node with the core network to the second node, control receiving, by the second node from the first node, data to be forwarded to the core network, perform, by the second node based on the request, an authentication with the core network on behalf of the first node, and control forwarding the received data from the second node to the core network while the first node is not connected with the second node.

According to an example implementation, a computer program product includes a computer-readable storage medium and storing executable code that, when executed by at least one data processing apparatus, is configured to cause the at least one data processing apparatus to perform a method including: controlling receiving, by a second node from a first node in a wireless network, a request to offload authentication of the first node with the core network to the second node, controlling receiving, by the second node from the first node, data to be forwarded to the core network, performing, by the second node based on the request, an authentication with the core network on behalf of the first node, and controlling forwarding the received data from the second node to the core network while the first node is not connected with the second node.

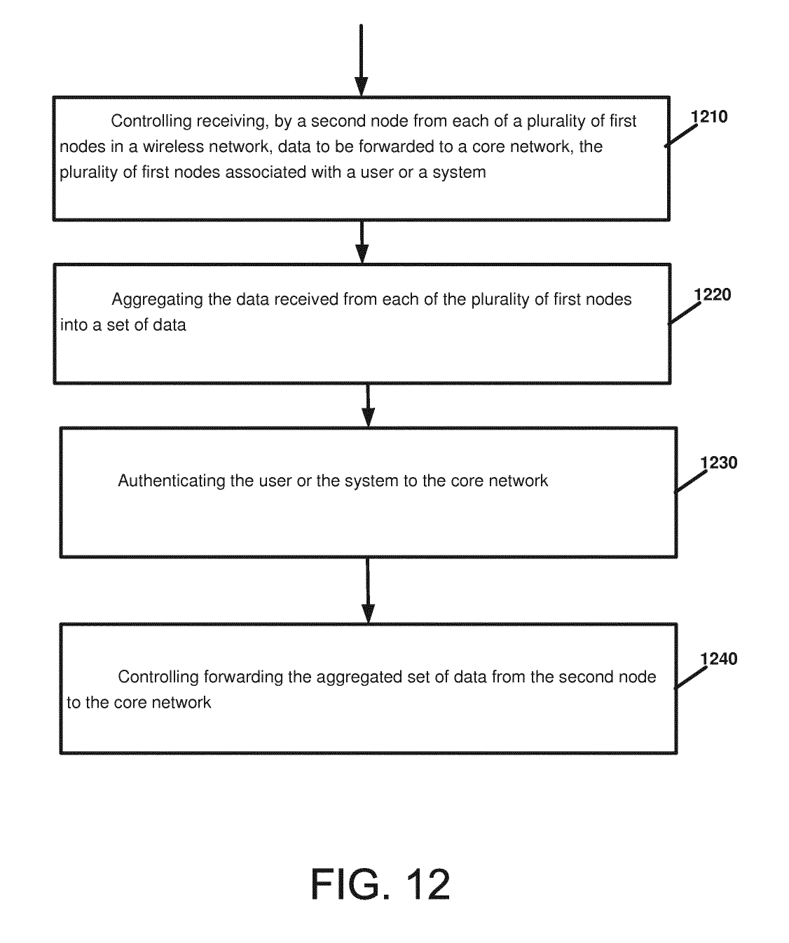

FIG. 12 is a flow chart illustrating operation of a wireless node according to an example implementation. Operation 1210 includes controlling receiving, by a second node from each of a plurality of first nodes in a wireless network, data to be forwarded to a core network, the plurality of first nodes associated with a user or a system. Operation 1220 includes aggregating the data received from each of the plurality of first nodes into a set of data. Operation 1230 includes authenticating the user or the system to the core network. Operation 1240 includes controlling forwarding the aggregated set of data from the second node to the core network.

In an example implementation of the method of FIG. 12, the authenticating may include authenticating, via communications with an authentication agent that has access to an encryption key associated with the user or the system, the user or the system to the core network.

In an example implementation of the method of FIG. 12, the controlling forwarding may include controlling forwarding the aggregated set of data from the second node to the core network while the second node is not connected to the plurality of second nodes.

In an example implementation of the method of FIG. 12, the plurality of first nodes includes a plurality of first wireless nodes, each of the first wireless nodes receiving and forwarding data associated with a user to the second node.

In an example implementation of the method of FIG. 12, the plurality of first nodes may include a plurality of first wireless nodes, each of the first wireless nodes receiving and forwarding health data or user monitoring data associated with a user to the second node.

In an example implementation of the method of FIG. 12, the plurality of first nodes may include a plurality of first wireless nodes associated with a health monitoring system for one or more users, each of the first nodes receiving and forwarding user monitoring data to the second node.

In an example implementation of the method of FIG. 12, the plurality of first nodes are associated with a first user or system, and wherein the aggregated set of data may include a first aggregated set of data associated with the first user or system, the method further including: controlling receiving, by the second node from each of a plurality of third nodes, data to be forwarded to a core network, the plurality of third nodes associated with a second user or a system, aggregating the data received from each of the plurality of third nodes into a second aggregated set of data, authenticating the second user or system to the core network, and controlling forwarding the second aggregated set of data from the second node to the core network.

According to an example implementation, an apparatus includes at least one processor and at least one memory including computer instructions, when executed by the at least one processor, cause the apparatus to: control receiving, by a second node from each of a plurality of first nodes in a wireless network, data to be forwarded to a core network, the plurality of first nodes associated with a user or a system, aggregate the data received from each of the plurality of first nodes into a set of data, authenticate the user or the system to the core network, control forwarding the aggregated set of data from the second node to the core network.

According to an example implementation, a computer program product includes a computer-readable storage medium and storing executable code that, when executed by at least one data processing apparatus, is configured to cause the at least one data processing apparatus to perform a method including: controlling receiving, by a second node from each of a plurality of first nodes in a wireless network, data to be forwarded to a core network, the plurality of first nodes associated with a user or a system, aggregating the data received from each of the plurality of first nodes into a set of data, authenticating the user or the system to the core network, and controlling forwarding the aggregated set of data from the second node to the core network.

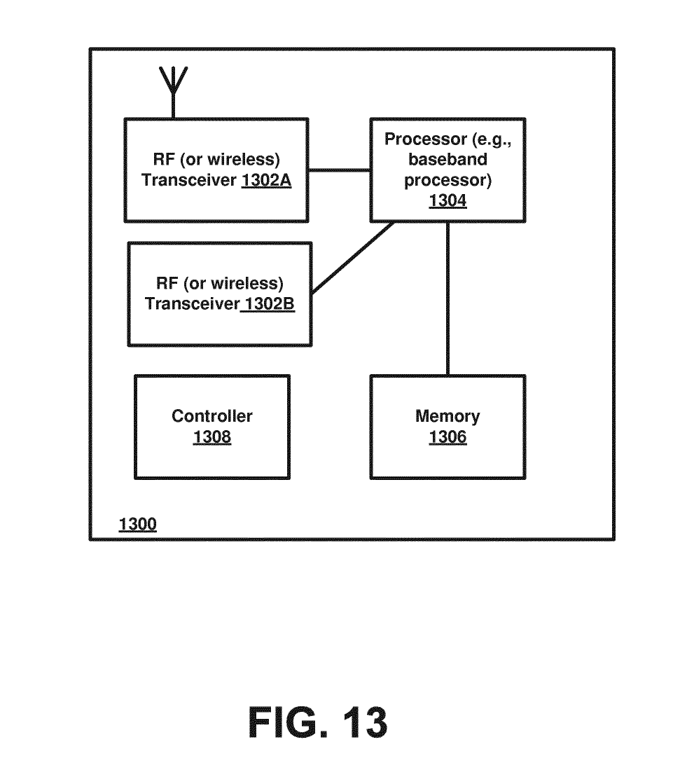

FIG. 13 is a block diagram of a wireless station (e.g., BS or user device) 1300 according to an example implementation. The wireless station 1300 may include, for example, two RF (radio frequency) or wireless transceivers 1302A, 1302B, where each wireless transceiver includes a transmitter to transmit signals and a receiver to receive signals. The wireless station also includes a processor or control unit/entity (controller) 1304 to execute instructions or software and control transmission and receptions of signals, and a memory 1306 to store data and/or instructions.

Processor 1304 may also make decisions or determinations, generate frames, packets or messages for transmission, decode received frames or messages for further processing, and other tasks or functions described herein. Processor 1304, which may be a baseband processor, for example, may generate messages, packets, frames or other signals for transmission via wireless transceiver 1302 (1302A or 1302B). Processor 1304 may control transmission of signals or messages over a wireless network, and may control the reception of signals or messages, etc., via a wireless network (e.g., after being down-converted by wireless transceiver 1302, for example). Processor 1304 may be programmable and capable of executing software or other instructions stored in memory or on other computer media to perform the various tasks and functions described above, such as one or more of the tasks or methods described above. Processor 1304 may be (or may include), for example, hardware, programmable logic, a programmable processor that executes software or firmware, and/or any combination of these. Using other terminology, processor 1304 and transceiver 1302 together may be considered as a wireless transmitter/receiver system, for example.

In addition, referring to FIG. 13, a controller (or processor) 1308 may execute software and instructions, and may provide overall control for the station 1300, and may provide control for other systems not shown in FIG. 13, such as controlling input/output devices (e.g., display, keypad), and/or may execute software for one or more applications that may be provided on wireless station 1300, such as, for example, an email program, audio/video applications, a word processor, a Voice over IP application, or other application or software.

In addition, a storage medium may be provided that includes stored instructions, which when executed by a controller or processor may result in the processor 1304, or other controller or processor, performing one or more of the functions or tasks described above.

According to another example implementation, RF or wireless transceiver(s) 1302A/1302B may receive signals or data and/or transmit or send signals or data. Processor 1304 (and possibly transceivers 1302A/1302B) may control the RF or wireless transceiver 1302A or 1302B to receive, send, broadcast or transmit signals or data.

An example of an apparatus may include means (1304, 1302A/1302B) for controlling sending, by a first node in a wireless network without the first node being authenticated to a core network, a message to a second node, the message including data to be forwarded to the core network, means (1304, 1302A/1302B) for offloading authentication of the first node with the core network from the first node to the second node, and means (1304, 1302A/1302B) for terminating controlling the sending the message by the first node without the first node performing authentication with the core network.

An example of an apparatus may include means (1304, 1302A/1302B) for controlling receiving, by a second node from a first node in a wireless network, a request to offload authentication of the first node with the core network to the second node, means (1304, 1302A/1302B) for controlling receiving, by the second node from the first node, data to be forwarded to the core network, means for performing, by the second node based on the request, an authentication with the core network on behalf of the first node while the first node is not connected with the second node, and means (1304, 1302A/1302B) for controlling forwarding the received data from the second node to the core network while the first node is not connected with the second node.

Another example of an apparatus may include means (1304, 1302A/1302B) for controlling receiving, by a first node from each of a plurality of second nodes in a wireless network, data to be forwarded to a core network, the plurality of second nodes associated with a user or a system, means (1304) for aggregating the data received from each of the plurality of second nodes into a set of data, means for (1304, 1302A/1302B) authenticating the user or the system to the core network, and means (1304, 1302A/1302B) for controlling forwarding the aggregated set of data from the first node to the core network.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Implementations may also be provided on a computer readable medium or computer readable storage medium, which may be a non-transitory medium. Implementations of the various techniques may also include implementations provided via transitory signals or media, and/or programs and/or software implementations that are downloadable via the Internet or other network(s), either wired networks and/or wireless networks. In addition, implementations may be provided via machine type communications (MTC), and also via an Internet of Things (IOT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, implementations of the various techniques described herein may use a cyber-physical system (CPS) (a system of collaborating computational elements controlling physical entities). CPS may enable the implementation and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various implementations of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

1-42. (canceled)

43. A method comprising:
controlling sending, by a first node in a wireless network without the first node being authenticated to a core network, a message to a second node, the message including data to be forwarded to the core network;
offloading authentication of the first node with the core network from the first node to the second node; and
terminating controlling the sending the message by the first node without the first node performing authentication with the core network.

44. The method of claim 43, further comprising:
connecting, by the first node to the second node, before controlling the sending of the message to the second node; and
disconnecting, by the first node from the second node, after terminating controlling the sending the message.

45. The method of claim 43, further comprising:
controlling sending a key from the first node to the second node, the key, or a derivation thereof, to be used by the second node to authenticate the first node to the core network or perform authentication with the core network on behalf of the first node, while the first node is not connected to the second node.

46. The method of claim 43, wherein the offloading authentication comprises authenticating, by the second node, the first node to the core network while the first node is disconnected from the second node; and
the method further comprising forwarding, by the second node, the data to the core network after the second node has authenticated the first node to the core network and while the first node is disconnected from the second node.

47. The method of claim 43, wherein the offloading authentication comprises performing, by the second node on behalf of the first node, mutual authentication with the core network while the first node is disconnected from the second node.

48. The method of claim 43, further comprising:
authenticating, by the second node via communications with an authentication agent that has access to an encryption key associated with the first node, the first node to the core network while the first node is disconnected from the second node.

49. An apparatus comprising at least one processor and at least one memory including computer instructions, which, when executed by the at least one processor, cause the apparatus to:
send, by a first node in a wireless network without the first node being authenticated to a core network, a message to a second node, the message including data to be forwarded to the core network;
offload authentication of the first node with the core network from the first node to the second node; and
terminate controlling the sending the message by the first node without the first node performing authentication with the core network.

50. The apparatus of claim 49, wherein the computer instructions, when executed by the at least one processor, further cause the apparatus to:
connect, by the first node to the second node, before controlling the sending of the message to the second node; and
disconnect, by the first node from the second node, after terminating controlling the sending the message.

51. The apparatus of claim 49, wherein the computer instructions, when executed by the at least one processor, further cause the apparatus to:
send a key from the first node to the second node, the key, or a derivation thereof, to be used by the second node to authenticate the first node to the core network or perform authentication with the core network on behalf of the first node, while the first node is not connected to the second node.

52. The apparatus of claim 49, wherein the offloading authentication comprises authenticating, by the second node, the first node to the core network while the first node is disconnected from the second node; and
further comprises causing the apparatus to:
cause forwarding, by the second node, the data to the core network after the second node has authenticated the first node to the core network and while the first node is disconnected from the second node.

53. The apparatus of claim 49, wherein the offloading authentication comprises performing, by the second node on behalf of the first node, mutual authentication with the core network while the first node is disconnected from the second node.

54. The apparatus of claim 49, wherein the offloading authentication comprises authenticating, by the second node via communications with an authentication agent that has access to an encryption key associated with the first node, the first node to the core network while the first node is disconnected from the second node.

55. An apparatus comprising at least one processor and at least one memory including computer instructions, when executed by the at least one processor, cause the apparatus to:
receive, by a second node from a first node in a wireless network, a request to offload authentication of the first node with the core network to the second node;
receive, by the second node from the first node, data to be forwarded to the core network;
perform, by the second node based on the request, an authentication with the core network on behalf of the first node; and
forward the received data from the second node to the core network while the first node is not connected with the second node.

56. The apparatus of claim 55, wherein the performing authentication comprises authenticating, by the second node, the first node to the core network while the first node is in a sleep mode and is disconnected from the second node.

57. The apparatus of claim 55, wherein the performing authentication comprises:
receive, by the second node from the core network, an authentication request for the first node including a random number;
generate an authentication response based on the random number and a key associated with the first node;
send, by the second node to the core network, the authentication response.

58. The apparatus of claim 55, wherein the performing authentication comprises:
receive, by the second node from the core network, an authentication request including a random number;
forward, by the second node to an authentication agent, the random number and a request for an authentication response based on the random number and a key associated with the first node that is stored by or accessible to the authentication agent;
receive, by the second node from the security agent, an authentication response based on the random number and the key associated with the first node; and
send, by the second node to the core network, the authentication response.
